(19) United States
(12) Patent Application Publication
(10) Pub. No.: US 2019/0082148 A1
(43) Pub. Date: Mar. 14, 2019

(54) Drone Stabilizing Handgrip

(71) Applicant: Jeffrey Overall, Fountain Valley, CA (US)

(72) Inventor: Jeffrey Overall, Fountain Valley, CA (US)

(21) Appl. No.: 15/704,186

(22) Filed: Sep. 14, 2017

(51) Int. Cl. H04N 7/18; B64C 39/02; H04N 5/232

(52) U.S. Cl. CPC H04N 7/185; B64C 2201/127; H04N 5/23293; B64C 39/024

(57) ABSTRACT

A method of manually photographing or recording video footage with a drone or other unmanned vehicle. The drone is securely attached to a handgrip or handgrips. The method enables stabilization and control of the images a drone camera records. Risk of damage to the drone is reduced, while quality of the captured footage is enhanced. A phone or other portable electronic display is attached to allow viewing and control of recorded images.

### TECHNICAL FIELD

The present invention relates to drones with cameras. More specifically, it enables the stabilized manipulation of the drone when used as a hand-held camera and allows simultaneous viewing of recorded images transmitted to a phone or portable electronic display.

### LIST OF PRIOR ART

U.S. Patents

| Patent Number: | Kind Code: | Grant Date: | Patentee: |
|---|---|---|---|
| 2,239,201 | A | 1941 Apr. 22 | Pyzel |
| 4,017,168 | A | 1977 Apr. 12 | Brown |
| 4,306,790 | A | 1981 Dec. 22 | Adams |
| 4,545,660 | A | 1985 Oct. 8 | Rudolf |
| 4,943,820 | A | 1990 Jul. 24 | Larock |
| 5,373,334 | A | 1994 Dec. 13 | Nicolaci |
| 7,412,793 | B2 | 2008 Aug. 19 | Moody |
| 7,372,502 | B2 | 2008 May 13 | Gonzalez |
| 8,388,243 | B1 | 2013 Mar. 5 | Smith |
| 8,657,507 | B2 | 2014 Feb. 25 | Di Leo |
| 8,801,302 | B2 | 2014 Aug. 12 | Rush |
| 9,563,200 | B2 | 2017 Feb. 7 | Rischmuller |

### Nonpatent Literature Documents

Above the World: Earth through a Drone's Eye. Te Neues Publishing Group, 2016.
“DJI Wins a 2017 Emmy® Award for Technology and Engineering.” Newsshooter, 30 Aug. 2017, www.newsshooter.com/2017/08/31/dji-wins-a-2017-emmy-award-for-technology-and-engineering/. Accessed 13 Sep. 2017.

### BACKGROUND/DISCUSSION OF PRIOR ART

Recently there has been great advancement in the capacity to photograph and record video and audio footage from drones and other unmanned vehicles. High quality camera, video, and audio recording equipment is integrated into many drones. Some drones have the capability to simultaneously transmit the recorded images to a phone or other portable electronic display (“PED”). These attributes make it desirable to manually photograph and record with drones. Controlling drones remotely allows a user to capture aerial footage from a drone. However, it is easier to control the drone manually when recording or photographing at short range. To fully utilize the manual recording capabilities, a user must be able to hold the drone in a stable position while viewing the real-time transmission of recorded images on a PED.

Unfortunately, drones and other unmanned vehicles are not configured to be manipulated manually. Many inventions enhance the stability necessary to shoot with cameras, but do not provide a means for stabilizing the body of a drone. This can make hand-held recording with a drone difficult. Gripping the drone directly can cause damage to the body or other components. Drones are relatively bulkier than cameras and not designed to be gripped by hand. The inability to securely grip the drone can cause dropping and damage to the drone or camera. Holding the drone for extended periods of time is difficult because of the unnatural, wide grip required by the dimensions of most drones. The lack of stability while recording can result in poor quality footage. Recording ability is further compromised by the difficulty of viewing the recording footage on a PED while holding the drone. Drones do not contain interfaces to allow a user to view recording images. The user is forced to either insecurely attach a PED to the drone, increasing the likelihood of damage, or hold the PED in one hand and the drone in the other. The latter arrangement divides the user's attention and hinders the ability to safely manipulate the drone. These obstacles have prevented the effective use of drones as handheld cameras.

### Advantages

The present invention solves these problems by allowing the user to stabilize the drone while simultaneously viewing recorded images. Handgrips are used to allow a more secure grip than holding the drone directly. This reduces the risks of damaging or dirtying the drone. Also, the secure grip reduces the likelihood the drone will be dropped and damaged. The gripping method provides a more ergonomically sound means of holding the drone. The handgrips allow the user to hold the drone in a neutral grip, which is more natural than the supinated or pronated grips required when directly holding the drone. The handgrips allow the user to comfortably hold the drone for extended periods. The invention permits attachment of a PED. This enables the user to view the footage captured by the camera while holding the handgrips. Adjustments are made based on the transmitted images to capture the best photographic or video content. The handgrips make it easier to control the drone, allowing for greater stability and higher quality footage. Enhanced stability allows the user to avoid unwanted angular deviations in pan or tilt when in motion while recording. Also, the handgrips decrease the chance of the user inadvertently interfering with the camera lens and the recorded content.

### SUMMARY OF EMBODIMENTS

Disclosed is a method for attaching handgrips or handles to a drone. “Drone” is used broadly to mean any unmanned vehicle. The exemplary embodiment herein includes two opposing handgrips. The handgrips extend downward, away from the user. The handgrips in the exemplary model are angled outward away from the drone. This enables an ergonomically ideal neutral grip. The angle also provides space between drone and handgrips for the user to adjust grip and aim the drone camera.

The handles are connected by and attached to a truss. A drone harness is configured to receive the drone. The harness is comprised of plastic or polycarbonate material sufficient to support the weight of the drone. The harness has three sides, two sides connect to and extend downward from the truss. The third side connects the other two sides at the ends distal to the truss. The drone harness can be coupled to the truss by threaded insertion, snap hooks, clamping, hinging, a combination thereof, or any other adequate method. The harness is coupled by threaded screws in the exemplary embodiment. The truss contains two openings corresponding to threaded sockets in the two connecting sides of the drone harness. Screws are used to attach the drone harness to the truss.

A PED link is positioned on top of the truss. The PED link permits attachment of a mount to display a PED. In the exemplary embodiment a threaded screw and nut comprise the PED link. The mount is threadedly attached to the link. The nut permits adjustment of the mount. The mount is capable of securely fastening the PED. The mount allows adjustment of the PED interface orientation so the user can conveniently view and control the recorded images.

### Operation

The drone is placed in the drone harness. The drone harness supports the bottom and sides of the drone. The drone harness is coupled with the truss. When coupled, the truss abuts the top of the drone. Together, drone harness and truss secure the drone in a stationary position. The drone is inserted so the drone camera is facing away from the user. “Camera” is used herein broadly to mean “imaging device.” The drone is abutted to the drone harness in a position that allows optimal weight distribution in stabilizing and controlling the drone. Usually, this will require the middle of the drone to abut the drone harness and truss. The handgrips are perpendicular to the optical path, preventing user interference while recording.

A PED is attached to the mount. The PED is inserted or otherwise attached to the mount to display the recording images. The mount allows orientation of the PED to allow the user to view recorded footage while simultaneously controlling the handgrips. Recorded images are transferred to the PED either by hardwire or wirelessly. The proximity of the drone to the PED affords easy connection by USB cable or other means. The handgrips are used to stabilize and smoothly aim the drone camera while photographing or recording. The PED applications allow control of the photographs and video footage recorded.

Alternate embodiments couple the harness directly to the drone handgrips. Based on the dimensions and weight of the drone it may be desirable to widen the drone harness while maintaining ergonomically optimal handgrip position. Attaching the drone harness directly to the handgrips can accomplish this.

Alternate embodiments are comprised of only one handgrip or additional handgrips. Lighter drones may only require one handle to allow stable recording. Additional handgrips, three or more, allow the drone to be held in different positions relative to the user's body. This allows the user to adapt to different vantage points and record in different states of motion.

Alternative embodiments could include handgrips extending in different directions. The handgrips could be oriented to extend upward, toward the user or could be aligned with the truss to face outward from the drone.

Alternate embodiments can use a different method to attach the PED mount to the drone stabilizing handgrip. Snap hooks, clamping or other methods of attachment are viable.

### BRIEF DESCRIPTION OF THE DRAWINGS

FIG. 1 is a top perspective view of the drone stabilizing handgrip without a drone or PED attached. The drone harness is attached.

FIG. 2 is an exploded front view of the drone stabilizing handgrip and PED mount.

FIG. 3 is a top view of the drone stabilizing handgrip without the threaded screws.

FIG. 4 is a top view of the drone harness.

FIG. 5A is a perspective view of the drone stabilizing handgrip in operation.

FIG. 5B is a front view of the drone stabilizing handgrip in operation.

### DRAWING: LIST OF REFERENCE NUMERALS

11. Drone stabilizing handgrip
20. Handgrips
22. Drone harness
24. Truss
25. Truss openings
26. Screws
27. Sockets
28. PED link
30. Mount
32. PED
40. Drone
42. Camera

### DETAILED DESCRIPTION OF DRAWING

It is to be understood that the invention is not limited in its application to the details of the particular arrangement shown since the invention is capable of other embodiments. Also, the terminology used herein is for description and not limitation.

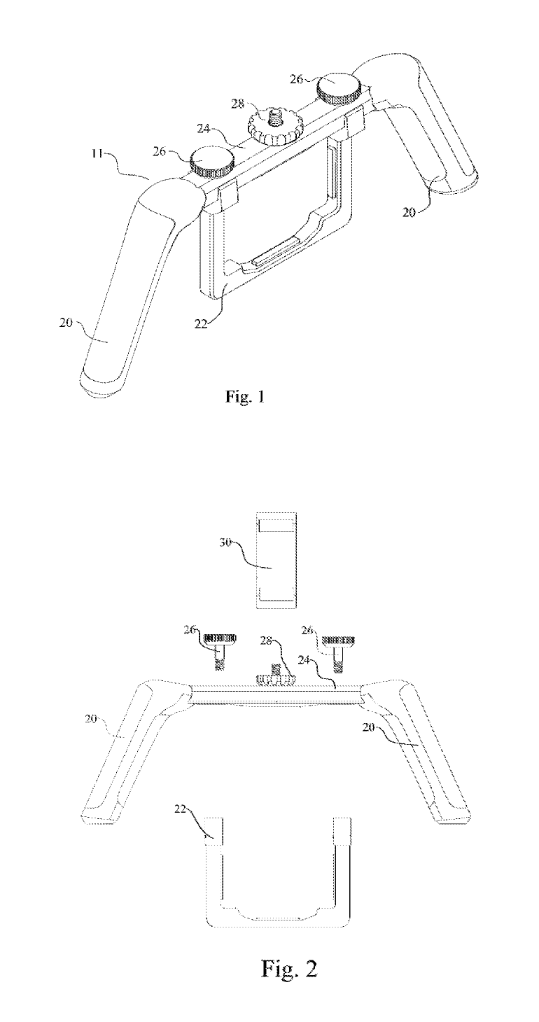

FIG. 1 shows a drone stabilizing handgrip 11 with components attached. Handgrips 20 are connected by the truss 24. In this embodiment the handgrips 20 are angled outward to permit the most ergonomically sound neutral grip. In other embodiments handgrips 20 are perpendicular to the truss 24 or otherwise configured to permit the desired orientation to the camera. In the exemplary embodiment the handgrips 20 extend downward. The length of the truss 24 and angle of the handgrips 20 enable for the user to grip and manipulate the drone stabilizing handgrip 11 without contacting or being otherwise constrained in movement by the drone harness 22.

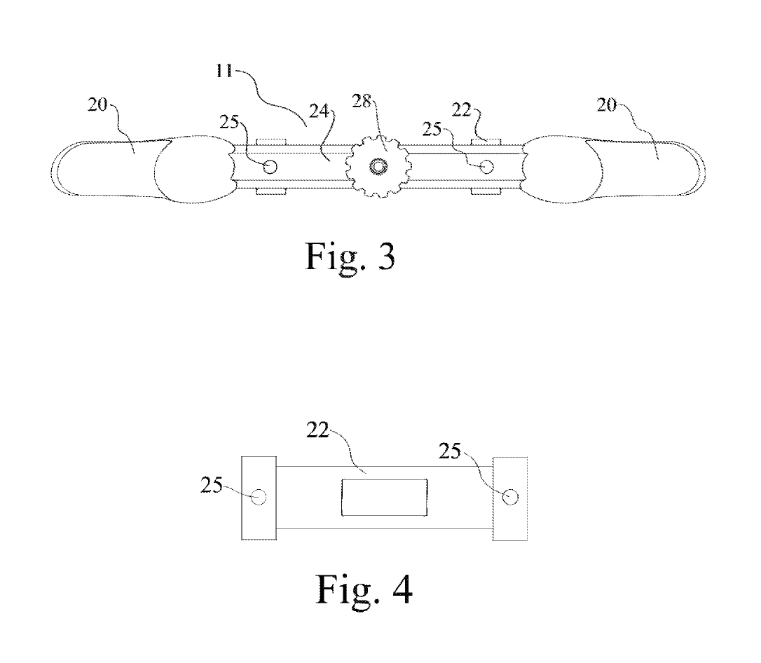

The drone harness 22 is configured to abut the truss 24. Screws 26 are used to couple the drone harness 22 to the truss 24. The screws 26 in this embodiment include grooved knobs for easy installation. The screws 26 are inserted through the truss openings 25 seen in FIG. 3. A PED link 28 atop the truss 24 enables attachment of a PED. In this embodiment the PED link 28 is comprised of a threaded screw and nut. The nut is used to adjust PED orientation.

FIG. 2 is an exploded view of the drone stabilizing handgrip 11 components and a mount 30. The screws 26 are positioned above the openings in the truss 24. The drone harness 22 is positioned below the truss openings 25. To attach the drone, sockets 27 in the drone harness 22 are aligned and abutted with the threaded openings 25. The threaded screws 26 are inserted into the truss openings 25 and sockets 27 to achieve coupling.

The mount 30 is attached to the PED link 28 to permit viewing of the footage recorded on the drone. This exemplary mount 30 permits threaded coupling. Alternate embodiments of mount 30 configuration and coupling are possible so long as they permit orientation of the PED to allow convenient viewing by the user.

FIG. 3 shows a top view of the alignment of the drone stabilizing handgrip 11. The drone harness 22 is positioned below the truss openings 25. The drone harness 22 has sockets 27, as seen in FIG. 4. The sockets 27 are configured to receive the screws 26 and enable coupling. The sockets 27 and truss openings 25 are aligned to permit installation. In this embodiment all the components are aligned parallel to the truss 24. This alignment requires abutment to a small surface area of the drone 40 while allowing the user to easily balance the drone 40 while recording. Direct contact with a small surface area permits coupling with drones of different dimensions and protrusions.

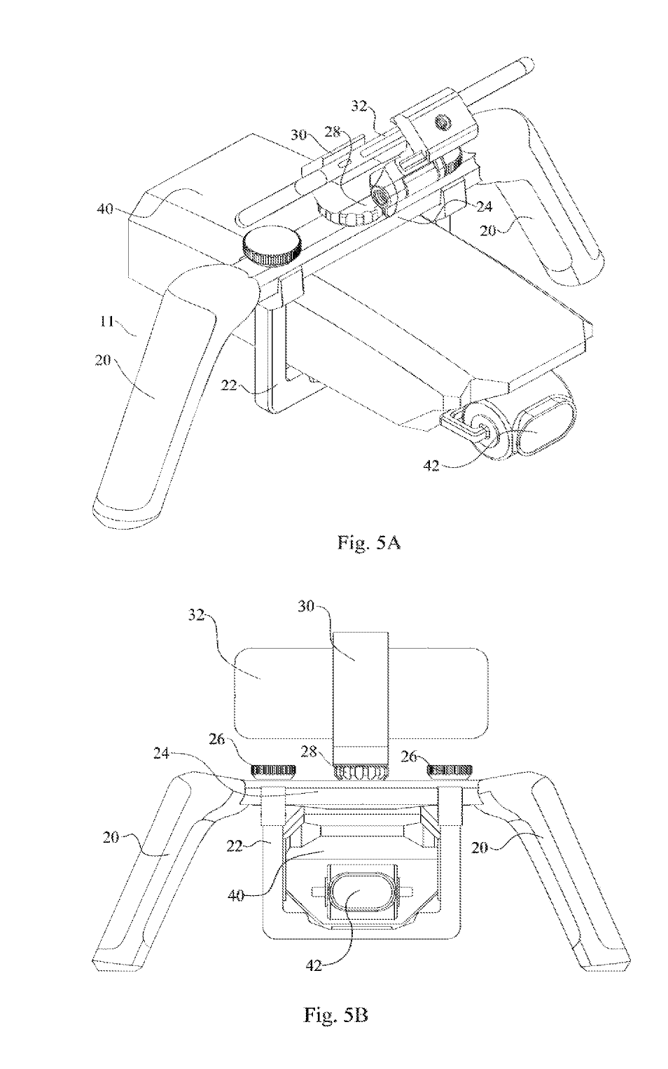

FIG. 5A-B depict the drone stabilizing handgrip 11 with all elements of the method attached. The drone 40 is secured between the drone harness 22 and truss 24. The three sides of the drone harness 22 and underside of the truss 24 abut the drone 40 and apply external pressure. The mount 30 is coupled with the PED link 28. A PED 32 is coupled by the mount 30. The PED 32 is angled upward and toward the user. The PED 32 is oriented so the user can easily view and adjust the interface while operating the drone stabilizing handgrip 11.

The camera 42 faces away from the user and in the opposite direction of the PED 32. The camera 42 is positioned perpendicular to the drone stabilizing handgrip U. The handgrips 20 are far enough to the side and behind the camera 42 to prevent the user from contacting the drone 40 or interfering in anyway with the optical path of the camera 42. Alternate handgrip 20 positioning behind the camera 42 and above or below the drone 40 are possible. Handgrip positioning must enable the user to securely grip and manipulate the drone stabilizing handgrip 11 while not interfering with the optical path or contacting the drone.

FIG. 5B depict the drone harness 22 and truss 24 fully enclosing and closely abutting the drone 40 sides adjacent to the side the camera 42 is located on. The secure fit allows the attachment with contact to small surface area of the drone 40. This permits attachment of drones that do not have retractable wings or include other protrusions. Here, the wings of the exemplary drone 40 are retracted.

I claim:

1. A method of filming or photographing manually with a drone, comprising
a. Two handgrips,
b. A harness configured to hold and stabilize a drone with a camera,
c. Said harness being attached to said handgrips, whereby the drone is attached to said handgrips,
d. A PED attached to said handles, whereby images recorded by the drone camera are viewed and controlled

2. The method recited in claim 1, wherein there is one handgrip

3. The method recited in claim 1, wherein there are additional handgrips

4. A method for attaching handles to a drone with a camera, comprising:
a. A harness configured to hold and support the drone;
b. A truss, to which said harness attaches,
c. Said truss and said harness abutting the drone and holding it in position,
d. Two handles attached to the truss,
e. A mount attached to said truss,
f. Said mount providing means to attach a PED,
a. Said PED providing a means to control and view footage recorded by the drone camera.

5. The method recited in claim 4, wherein there is one handgrip

6. The method recited in claim 4, wherein there are additional handgrips

7. An apparatus for attaching handles to a drone, comprising:
a. A harness configured to hold and support said drone,
b. A truss, to which said harness attaches
c. Two handgrips attached to said truss
d. Said harness being capable of coupling with said truss, whereby the drone is secured in a stable position.

8. The apparatus recited in claim 7, wherein there is one handgrip

9. The apparatus recited in claim 7, wherein there are additional handgrips

10. The apparatus recited in claim 7, wherein the harness is attached directly to the handgrips

11. An apparatus for attaching handles to a drone, comprising:
a. A harness configured to hold and support said drone,
b. A truss, to which said harness attaches
c. Two handgrips attached to said truss
d. Said harness being capable of coupling with said truss, whereby the drone is secured in a stable position,
e. A mount attached to said truss, whereby a PED is attached.

12. The apparatus recited in claim 11, wherein there is one handgrip

13. The apparatus recited in claim 11, wherein there are additional handgrips
